(19) United States
(12) Patent Application Publication
(10) Pub. No.: US 2007/0246680 A1
(43) Pub. Date: Oct. 25, 2007

(54) Air valve structure for inflatable articles

(76) Inventor: Richard Chao, Taipei City (TW)

Correspondence Address: BIRCH STEWART KOLASCH & BIRCH, PO BOX 747, FALLS CHURCH, VA, 22040-0747, US

(21) Appl. No.: 11/406,250

(22) Filed: Apr. 19, 2006

(51) Int. Cl. F16K 31/00

(52) U.S. Cl. 251/340

(57) ABSTRACT

An air valve structure for inflatable articles includes a cylindrical body, at least one venthole on a valve base, a valve cover coupled to the valve base and having a containing groove, and a valve pillar in the containing groove and including a tube body passing through a through hole. The tube body includes an air guide hole and a pressing portion, and the valve cover is coupled to a locking member, and the valve pillar displaces up and down in the containing groove to define a closed state and an open state, and the locking member and the valve pillar define a position limit relation to prevent the valve pillar from being touched accidentally or an excessively large air pressure from causing an air leak. With the foregoing measures, the air valve structure of the invention provides an easy operation and achieves an airtight effect.

### FIELD OF THE INVENTION

The present invention relates to an air valve, and more particularly to an air valve structure used for inflatable articles.

### BACKGROUND OF THE INVENTION

Inflatable articles such as inflatable pillows, inflatable beach balls, inflatable dolls, inflatable toys, inflatable mattresses, inflatable boats, inflatable life buoys, inflatable lifeboat, inflatable life jackets or any article that requires inflating the inflatable article for fixing their shape are used extensively in our daily life. Since polyvinyl chloride (PVC) materials are used extensively in the industry, therefore the scope of using inflatable articles is broadened accordingly. However, traditional inflatable articles usually adopt an air valve structure for inflating and discharging air, in addition to the use of an outer elastic skin for holding air.

Referring to R.O.C. Pat. No. M244386 entitled “Leakproof air valve” for a traditional air valve, the air valve of an inflatable article is usually designed as a one-way valve to prevent the valve of the inflatable article from leaking, and the valve can be opened inwardly only, so that when the inflatable article is inflated, the pressure difference of the outside causes the one-way valve to push inward. However, the drawback of such valve resides on that the valve cannot be opened by the pressure difference if the pressure inside the inflatable article is larger them the pressure produced by the inflation, and the inflatable article cannot be inflated further. If it is necessary to discharge the air, then a rod will be used to pop open the inwardly propped one-way valve to create an airflow path, so as to discharge the air in the inflatable article. The foregoing structure makes the operation for discharging air from the inflatable article very difficult, and it requires a tool to press a check mechanism in the air valve in order to release the air in the inflatable article. Such arrangement not only makes the air discharging operation complicated and inconvenient, but also requires a tool to press the air check mechanism, which possibly damages the check mechanism and the surfaces around the air valve of the inflatable article, increases the air inflating time and causes a low inflating efficiency, and even causes dangers to a victim who needs to inflate a life buoy, a lifeboat, or a life jacket immediately.

Referring to U.S. Pat. No. 2,936,935, this patented invention includes a valve cover, an opening disposed at the center of the valve cover, a valve pillar passing through the opening of the valve cover and tightly coupling with the opening, and a valve base coupled to the valve cover, wherein the valve cover includes a flange, a stairway-like coupling portion formed at an end of the valve pillar and having a penetrating hole disposed at the center of the coupling portion, and the valve base includes an inwardly concave connecting surface therein and a circular protrusion disposed at the center of the connecting surface and securely coupled with the coupling portion of the valve pillar, and the coupling portion is closely engaged with the flange of the valve cover, such that when the invention is used, the coupling portion moves between the first position and the second position of the valve cover. If the coupling portion is situated at the first position, the device is shut; and if the coupling portion is situated at the second position, the device is opened. The device is applied to a general container for containing liquid or powder and provided for controlling the liquid or powder to be discharged from the container. Since the pressure inside the container is not larger than the outside, therefore the liquid or powder can be prevented from leaking out by tightly engaging the coupling portion with the circular protrusion and the flange of the valve cover. However, if this structure is used in an article containing gas, then the gas inside the article may leak. If the article is pressed or squeezed or the air pressure inside the article is too large, then the valve pillar may be affected by the air pressure to produce a slight displacement or a gap between the coupling portion and the circular protrusion, so that the gas inside the article may leak from the gap.

Referring to U.S. Pat. No. 3,276,640, this patented invention includes a flange and a coupling portion, so that the device is shut if the coupling portion is situated under the flange, and the device is opened, if the coupling portion is situated above the flange. The characteristic of this invention resides on that the relative positions of the coupling portion and the flange disposed inside the valve cover are used to control and turn on or off the device. However, the device is also applied for containers that contain liquid, and if it is necessary to apply the structure to an inflatable article, then the leakproof effect is still not good, since the air pressure inside the inflatable article is larger than the outside, and any squeeze or pressing on the surface of the inflatable article will increase the air pressure inside the inflatable article, and thus an air leakage will occur and cause inconvenience to users.

### SUMMARY OF THE INVENTION

The primary objective of the present invention is to overcome the foregoing shortcomings and avoid the existing deficiencies by providing an air valve structure capable of preventing air from leaking from the air valve that may lower the performance of an inflatable article or cause inconvenience to users.

To achieve the foregoing objective, a valve base of the invention includes a cylindrical body and at least one venthole, and couples a valve cover to form a containing groove, and the containing groove includes a valve pillar therein, and the valve pillar has a tube body that passes through the through hole, and the interior of the tube body includes an air guide hole, and the tube body has a pressing portion, and the valve cover is coupled to a locking member, such that if a force is exerted onto the valve pillar, the valve pillar will displace up and down in the containing groove to create an on or off state, and the locking member and the valve pillar constitute a limit position relation, so as to prevent an air leakage caused by touching the valve pillar by mistake or having an excessively large air pressure. With the foregoing measure, the air valve becomes more airtight and the operation becomes simpler and easier.

### BRIEF DESCRIPTION OF THE DRAWINGS

FIG. 1 is a perspective view of the present invention;

FIG. 2 is an exploded view of a portion of the structure of the present invention;

FIG. 3 is another exploded view of a portion of the structure of the present invention; and

FIGS. 4A and 4B are schematic views of successive movements of the present invention.

### DETAILED DESCRIPTION OF THE PREFERRED EMBODIMENTS

The present invention will now be described in more detail hereinafter with reference to the accompanying drawings as follows:

To make it easier for our examiner to fully understand the objective of the invention, its structure, innovative features, and performance, we use a preferred embodiment together with the attached drawings for the detailed description of the invention. Only some embodiments of the present invention have been illustrated in the drawings, but it should be pointed out that many other modifications are conceivable within the scope of the following claims.

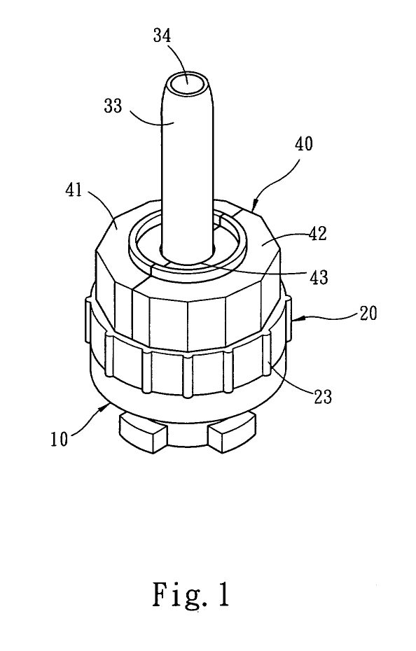

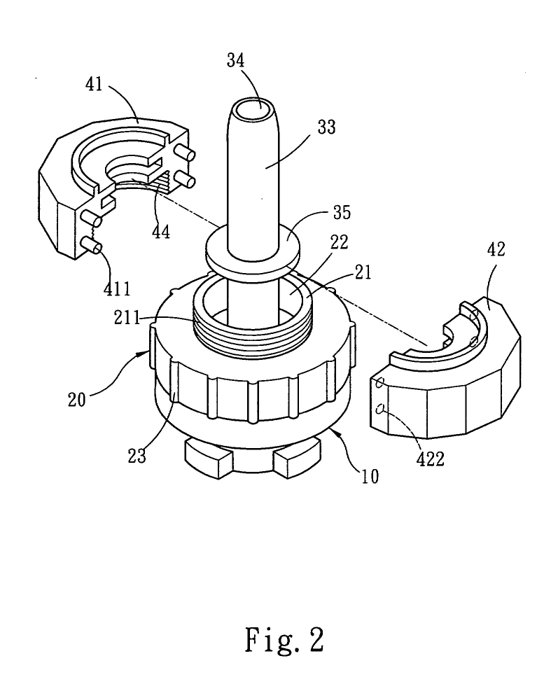

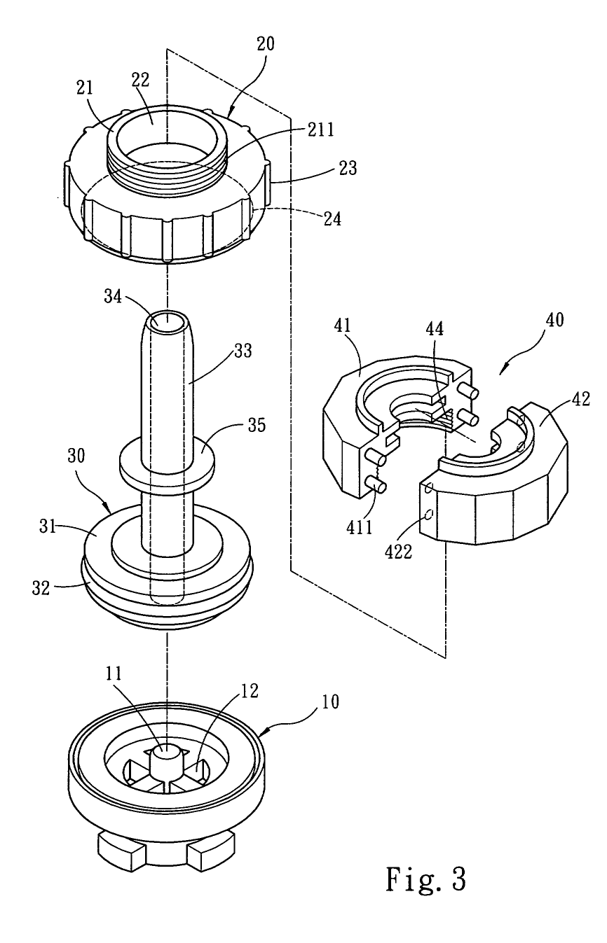

Referring to FIGS. 1 to 3 for the perspective view and exploded views of the present invention, the air valve structure for inflatable articles of the invention comprises a valve base 10, a cylindrical body 11 disposed on the valve base 10 and at least one venthole 12 disposed at the bottom of the valve base 10, wherein the ventholes 12 are disposed equidistantly around the periphery of the cylindrical body 11, and the upper end of the valve base 10 is fixed to a valve cover 20, and the valve cover 20 includes a rib 23 for users to apply a force thereon, and the valve cover 20 includes a connecting portion 21 disposed on its surface and a through hole 22 disposed in the connecting portion 21, and a containing groove 24 is formed between the valve base 10 and the valve cover 20, and the containing groove 24 includes a valve pillar 30 therein, and the valve pillar 30 has an isolating portion 31, and the isolating portion 31 includes an airtight ring 32 pressing a wall of the containing groove 24 and a tube body 33 passing through the through hole 22, and the tube body 33 includes an air guide hole 34 therein, and the tube body 33 includes a pressing portion 35, and the valve cover 20 is coupled to a locking member 40, and the locking member 40 is formed by engaging two half portions 41, 42, and the half portions 41, 42 include corresponding protruded positioning portion 411 and positioning hole 422 coupled with each other.

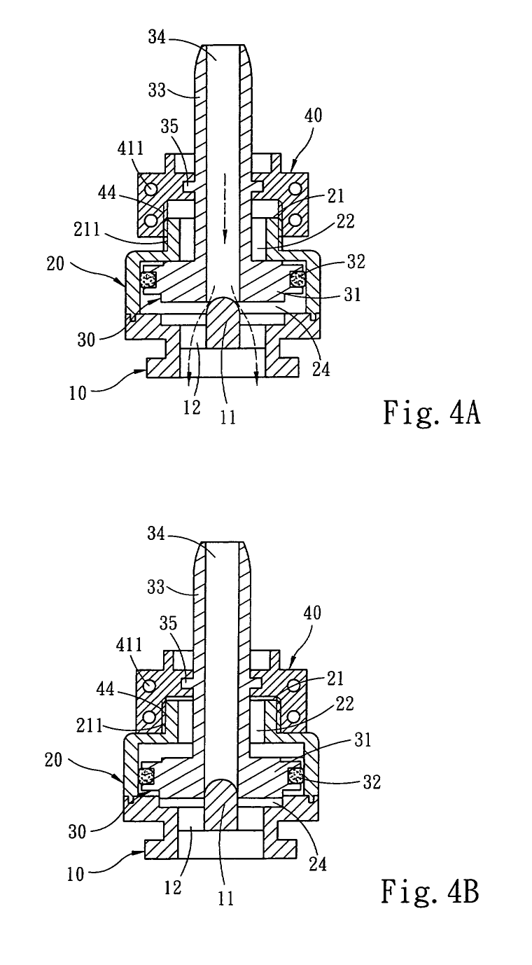

Referring to FIGS. 4A and 4B for the schematic views of successive movements of the present invention, an isolating portion 31 of the valve pillar 30 is disposed in the containing groove 24, and the isolating portion 31 includes an airtight ring 32 for pressing the wall of the containing groove 24 to prevent air from leaking, and the valve pillar 30 presses the upper end of the containing groove 24 to define a first position for interconnecting the air guide hole 34 and the venthole 12, so that air can pass from the air guide hole 34 of the tube body 33 into the venthole 12 for the inflation (as shown in FIG. 4), and a force can be exerted onto the valve pillar 30 to produce a displacement path in the containing groove to define a second position for closing the airflow path. Now, the cylindrical body 11 passes into and isolates the air guide hole 34, so that users can apply a force to rotate the locking member 40, and the locking member 40 displaces the connecting portion 21 downward by using a thread portion 44, 211 to press the pressing portion 35, so that the valve pillar 30 can be displaced easily from the first position to the second position. The locking member 40 props the pressing portion 35 of the tube body 33 and the valve pillar 30 constitutes a position limit relation to effectively prevent users from touching the valve pillar 30 by accident or an excessively large air pressure which will cause the valve pillar 30 to separate from the second position and will result an air leak as shown in (FIG. 4B).

In summation of the description above, the valve pillar 30 can be displaced up and down in the containing groove by exerting a force onto the valve pillar 30 to define an open or close state, and the invention has an easy-to-operate feature, and the isolating portion 31 includes an airtight ring 32 (which could be a rubber ring) for pressing the wall of the containing groove 24 to prevent air from leaking, and the locking member 40 and the valve pillar 30 can be secured to define a position limit relation to prevent users from touching the valve pillar 30 by mistake or the pressure is too large that causes an air leak. The present invention not only provides a simple and easy operation, but also improves the airtightness of the air valve greatly.

While the invention has been described by means of specific embodiments, numerous modifications and variations could be made thereto by those skilled in the art without departing from the scope and spirit of the invention set forth in the claims.

In summation of the above description, the present invention herein enhances the performance than the conventional structure and further complies with the patent application requirements and is submitted to the Patent and Trademark Office for review and granting of the commensurate patent rights.

What is claimed is:

1. An air valve structure for inflatable articles, comprising:
a valve base, including a cylindrical body and at least one venthole disposed on said valve base;
a valve cover, coupled to said valve base, and including a containing groove disposed between said valve base and said valve cover, a connecting portion disposed on the surface of said valve cover and a through hole disposed in said connecting portion;
a valve pillar, disposed in said containing groove and including an isolating portion, an airtight ring disposed on said isolating portion for pressing a wall of said containing groove, and a tube body passing through said through hole, and said tube body and the interior of said isolating portion having an interconnected air guide hole, and said tube body including a pressing portion;
a locking member, coupled to said connecting portion, and having a penetrating hole for passing said tube body and a thread portion disposed corresponding to said connecting portion, such that said connecting portion produces a displacement path for pressing said pressing portion of said valve pillar when a force is applied to said connecting portion.

2. The air valve structure for inflatable articles of claim 1, wherein said valve pillar defines a first position for interconnecting said air guide hole with said venthole and using said locking member to press said pressing portion and a second position for producing a displacement path in said containing groove to isolate said cylindrical body from said air guide hole.

3. The air valve structure for inflatable articles of claim 1, wherein said locking member is a screw nut.

4. The air valve structure for inflatable articles of claim 1, wherein said locking member is comprised of two half portions, said half portions include a positioning hole and a protruded positioning portion engaged with each other.

5. The air valve structure for inflatable articles of claim 1, wherein said valve cover includes a rib for facilitating applying a force.

6. The air valve structure for inflatable articles of claim 1, wherein said pressing portion has a cross-sectional area larger than the cross-sectional area of said through hole.

7. The air valve structure for inflatable articles of claim 1, wherein said ventholes are disposed equidistantly around the periphery of said cylindrical body.
